(19) United States
(12) Patent Application Publication
(10) Pub. No.: US 2010/0166005 A1
(43) Pub. Date: Jul. 1, 2010

(54) MECHANISM FOR UPDATING THE PARAMETERS OF A PSEUDOWIRE

(75) Inventors: Frederic Jounay, Pleumeur Bodou (FR); Philippe Niger, Lannion (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/669,719

(22) PCT Filed: Jul. 18, 2008
(86) PCT No.: PCT/FR08/51363

§ 371 Date: Feb. 25, 2010

(30) Foreign Application Priority Data
Jul. 19, 2007 (FR) 07/56625

(51) Int. Cl. H04L 12/56

(52) U.S. Cl. 370/401

(57) ABSTRACT

A method is provided for communicating between first and second routers, the routers being part of a packet-switched network. The method includes a stage of transmitting data over a pseudowire set up between the first and second routers, the data being transmitted in accordance with a parameter of the pseudowire. The method includes at least one step of sending a modification request message of the parameter at the initiative of one of the two routers, to the other router, and during the stage of transmission over the pseudowire. Also, a method is provided for processing data transmitted over such a pseudowire. The method includes a stage of transmission of data over the pseudowire, the data being transmitted in accordance with a parameter of the pseudowire. The method includes, during the transmission stage, at least one of the routers receiving a modification request message of the parameter of the pseudowire.

### CROSS-REFERENCE TO RELATED APPLICATIONS

This Application is a Section 371 National Stage Application of International Application No. PCT/FR2008/051363, filed Jul. 18, 2008 and published as WO 2009/016307 on Feb. 5, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is telecommunication, more particularly packet-switched networks.

### BACKGROUND OF THE DISCLOSURE

In a packet-switched network, data to be transmitted takes the form of packets processed by routers of the network until they reach their destination. The set of packets to be transmitted constitutes a data stream.

One example of a technology used in packet-switched networks to route data packets is the MultiProtocol Label Switching (MPLS) technology. The MPLS technology proposes adding to the header of the data packets one or more labels containing information enabling the routers of the network to determine the next hop that a packet must effect in order to reach its destination. The MPLS technology is described in more detail in Request For Comments RFC 3031 of the Internet Engineering Task Force (IETF).

However, the MPLS protocol can process only packets conforming to the Internet Protocol (IP).

To palliate that drawback, the PseudoWire Emulation Edge to Edge (PWE3) standardization group of the IETF defines a pseudowire concept for emulating a point-to-point link between two equipements of a packet-switched network using the IP/MPLS technology. Such pseudowires, defined in RFC 3985, are used to transmit data packets that do not conform to the IP protocol, such as data packets that conform to the ATM protocol, for example.

Referring to FIG. 1, a pseudowire pw1 is set up between a first router PE1 at the edge of a packet-switched network PSN and second router PE2 also at the edge of the PSN. Once the pseudowire pw1 has been set up, the first router PE1 sends a data stream over the pseudowire pw1 to the second router PE2.

The data constituting the data stream sent by the router PE1 is generated by a first customer edge equipment CE1 connected to the router PE1.

A second customer edge equipment CE2 connected to the router PE2 processes the data constituting the data stream received by the router PE2.

The router PE1 encapsulates data generated by the customer edge equipment CE1 with a predetermined format. An example of such a format is the volume of data. Thus the data to be encapsulated can be divided into blocks of 15 payload bits or into a fixed number of ATM cells. The router PE1 is configured to encapsulate the data with the predetermined format.

The router PE2 is configured to receive data with the predetermined format with which it was encapsulated by the router PE1.

Setting up the pseudowire pw1 is at the initiative of the router PE1 and is based on the exchange of set-up messages conforming to the Label Distribution Protocol (LDP) as defined in RFC 3036 and RFC 4477. Thus a first message to set up a pseudowire is sent by the router PE1 to the router PE2. This first set-up message includes an identifier SAII1 of the input router PE1 and an identifier TAII2 of the output router PE2, parameters of the pseudowire, and a first label. This first label is added to the header of all data sent by the router PE2 to the router PE1 over the pseudowire pw1.

On receiving this first pseudowire set-up message, the router PE2 sends the router PE1 a second pseudowire set-up message including an identifier SAII2 of the router PE2, an identifier TAII1 of the router PE1, parameters of the pseudowire and a second label. This second label is added to the header of all data sent by the router PE1 to the router PE2 over the pseudowire pw1.

Once the pseudowire pw1 has been set up between the router PE1 and the router PE2, it transmits data bidirectionally between the router PE1 and the router PE2.

Here, the customer edge equipment CE1 connected to the router PE1 is adapted to process data generated by the customer edge equipment CE2 connected to the router PE2.

Two forwarding equivalent classes (FEC) each of which identifies one transmission direction of the same pseudowire pw1 consist of the pairs {identifier SAII1 of router PE1/identifier TAII2 of router PE2} and {identifier SAII2 of router PE2/identifier TAII1 of router PE1}.

If a telecommunication operator managing the packet switch network PSN wishes to increase the bit rate on a pseudowire, it is necessary to modify the format of data transmitted over the pseudowire pw1. There are two solutions available to the operator for this purpose.

A first solution consists in destroying the pseudowire pw1 and setting up a new one adapted to transmit data with the new format.

FIG. 2 represents a diagram of the exchange of messages between the router PE1 and the router PE2 if that solution is used.

If a change of data format is effected in the first customer edge equipment CE1, said equipment informs the router PE1 of the change. The router PE1 then sends the router PE2 a message LWM1 requesting release of the resources used by the pseudowire pw1 for the uplink direction, i.e. from the router PE2 to the router PE1. On receiving this message LWM1, the router PE2 in turn sends the router PE1 a message LWM2 requesting release of the resources used by the pseudowire pw1 for the downlink direction, i.e. from the router PE1 to the router PE2.

On receiving the message LWM2, the router PE1 sends the router PE2 a first message LMM1 for setting up a new pseudowire. On receiving the set-up message LMM1, the router PE2 sends a second set-up message LMM2 to the input router PE1.

Each of the messages LMM1 and LMM2 for setting up the new pseudowire includes an FEC for identifying the new pseudowire and new parameters of the pseudowire, for the uplink direction in the first message LMM1 and for the downlink direction in the second message LMM2. Thus the new pseudowire set up is adapted to transmit data with the new format in each transmission direction.

Implementing such a solution requires interrupting the traffic of data packets between the router PE1 and the router PE2. Depending on the nature of the data carried by the pseudowire, such an interruption to the traffic can compromise quality of service, especially if the data is real-time data.

A second solution, represented in FIG. 3, consists in setting up a second pseudowire pw2 between the router PE1 and the router PE2. The elements of this figure already described with reference to FIG. 1 carry the same references and are not described again.

Each of the messages for setting up the pseudowire pw2 for the uplink direction and for the downlink direction includes an FEC separate from the corresponding FEC identifying the pseudowire pw1 and the new parameters of the new pseudowire pw2.

In that solution, on each modification of the data format with a view to modifying the pseudowire bit rate, a new pseudowire must be set up between the router PE1 and the router PE2.

Although ensuring continuity of service, such a solution has the drawback of being greedy for network resources, for example processing resources (storage capacity, calculation capacity, etc.) needed to distribute the bit rate overhead generated by the change of data format between the two pseudowires and bandwidth.

### SUMMARY

An aspect of the disclosure relates to a method of communicating data between first and second routers, said routers being part of a packet-switched network, said method including a stage of transmitting data over a pseudowire set up between the first and second routers, said data being transmitted in accordance with a parameter of said pseudowire.

Such a data communication method is noteworthy in that it includes at least one step of sending a modification request message of said parameter of said pseudowire at the initiative of one of the two routers, to the other router, and during the stage of transmission over the pseudowire.

The solution of an embodiment of the invention includes sending a message to request modification of a parameter of a pseudowire as a function of a new data format used by a router constituting one end of the pseudowire to encapsulate data to be sent over the pseudowire.

Such a modification request message is sent by a router constituting a first end of the pseudowire to another router constituting a second end of the pseudowire during a stage of transmission of data between the two routers over the pseudowire.

Thus the solution of an embodiment of the invention is free of the drawbacks of the prior art. Implementing the solution of an embodiment of the invention does not require interruption of service because the modification request message is sent and the pseudowire is adapted to transmit data.

Moreover, this solution does not require setting up a second pseudowire because the modification request message is not a message for setting up a new pseudowire.

The solution of an embodiment of the invention modifies the parameters of the pseudowire if the data format changes and retains the same pseudowire, i.e. it does not change the FEC of the pseudowire in the uplink direction or in the downlink direction and it does not interrupt service.

According to a first feature of the communication method of an embodiment of the invention, said method includes a configuration step after which the router sending said modification request message is able to accept to receive data transmitted in accordance with said modified parameter in compliance with said modification request.

After sending the other router the modification request message of the parameter of the pseudowire, the sending router is able to receive both data sent in accordance with the parameter of the pseudowire and data sent in accordance with the modified parameter of the pseudowire.

Thus transmission of data over the pseudowire is not interrupted by the communication method of an embodiment of the invention.

According to another feature of the communication method of an embodiment of the invention, said method includes a step of the router that initiates the sending of said modification request message receiving a second modification request message of the parameter of said pseudowire.

Thus the router that initiates the sending of the first modification request message is informed of the new parameter of the pseudowire for the downlink direction and of the format to use for data that it must encapsulate and send to the second router.

This is particularly beneficial for a pseudowire allowing bidirectional transmission of data between the first and second routers.

Note that the first and second routers must be adapted to send and receive modification request messages of a parameter of the pseudowire.

According to another feature of the communication method of an embodiment of the invention, said step of sending said modification request message is executed by said other router in response to a first modification request message of the parameter of the pseudowire.

If the pseudowire over which data is transmitted between two routers allows bidirectional transmission of data between the two routers, reception by the router receiving the first message to request modification of a parameter of the pseudowire triggers it sending a second modification request message of a parameter of the pseudowire for the second transmission direction.

The disclosure also provides a method of processing data transmitted over a pseudowire set up between first and second routers, said routers being part of a packet-switched network, said method including a stage of transmission of data over said pseudowire, said data being transmitted in accordance with a parameter of said pseudowire.

Such a data processing method is noteworthy in that it includes, during the transmission stage:

a step of at least one of the routers receiving a modification request message of the parameter of said pseudowire; and

a step of said router modifying the parameter of said pseudowire in accordance with said received modification request message.

If one of the routers constituting one end of the pseudowire receives a modification request message during the stage of transmitting data over the pseudowire, it takes the message into account, in contrast to what happens in the prior art, and it modifies the parameter of the pseudowire in accordance with what is indicated in the modification request message.

In the prior art, if this router received a message from the router constituting the other end of the pseudowire containing new parameters for a given FEC, and thus for a given pseudowire, it would not take those parameters into account because it would already have parameter values for that pseudowire.

This is why, in order to modify a parameter of the pseudowire, it is necessary either to destroy the pseudowire and set up a new one, the new parameters of the pseudowire being contained in the messages for setting up the new pseudowire, or to set up a second pseudowire.

According to a first feature of the data processing method of an embodiment of the invention, said method includes a step of said router marking data to be transmitted over the pseudowire having the parameter that has been modified.

By marking the data to be transmitted to the other router over the pseudowire, the router executing the marking step informs the other router of the data format change.

According to another feature of the data processing method of an embodiment of the invention, said data is marked by means of a label added to the header of said data, and the label is included in said received modification request message.

The configuration message received by the router includes a label in one of its fields. This label is associated with the data sent by the router over the pseudowire whose parameters have been modified. Such a label identifies data in the data stream conforming to the new format.

According to another feature of the data processing method of an embodiment of the invention said data is marked by means of a sequence number.

When sent over the pseudowire by the router, the data is assigned an identification parameter in the form of a sequence number.

When the router receives the modification request message, it resets the sequence numbers so that the first data sent over the pseudowire whose parameter has been modified has the sequence number one.

The disclosure further provides a router that is part of a packet-switched network, said router including means for transmitting data over a pseudowire set up between said router and a second router that is part of said packet-switched network, said data being transmitted in accordance with a parameter of said pseudowire.

Such a router is noteworthy in that it includes means for sending the second router a modification request message of the parameter of said pseudowire.

According to a first feature of the router of an embodiment of the invention, said router includes means for receiving a second modification request message of the parameter of said pseudowire.

The router of an embodiment of the invention also includes means for receiving a modification request message of the parameter of said pseudowire sent over said pseudowire, means for modifying the parameter of said pseudowire, and means for marking data to be transmitted over the pseudowire having parameters that have been modified.

The disclosure further provides a computer program product downloadable from a communication network and/or stored on a computer-readable medium and/or executable by a processor, said computer program product including program code instructions for executing the data communication method of an embodiment of the invention when said program is executed by a computer.

The disclosure further provides a computer program product downloadable from a communication network and/or stored on a computer-readable medium and/or executable by a processor, said computer program product including program code instructions for executing the data processing method of an embodiment of the invention when said program is executed by a computer.

The disclosure relates finally to a method comprising generating a signal that carries a modification request message of at least one parameter of a pseudowire set up between a first router and a second router, said first and second routers being part of a packet-switched network, and transmitting said signal over the pseudowire.

According to one feature of the signal of an embodiment of the invention, said signal includes:

an identifier of said pseudowire;

a parameter indicating that it is a modification request message of a parameter of the pseudowire;

a field containing the modified parameter of the pseudowire.

### BRIEF DESCRIPTION OF THE DRAWINGS

Other features and advantages become apparent on reading the description of preferred implementations given with reference to the drawings, in which:

FIG. 1, already described with reference to the prior art, represents a pseudowire set up as in the prior art between first and second routers of a packet-switched network;

FIG. 2, also described with reference to the prior art, represents a timing diagram of requests exchanged in a first prior art solution between first and second routers of a packet-switched network in order to eliminate a first pseudowire set up between the two routers and to set up a second pseudowire;

FIG. 3 represents two pseudowires set up in accordance with the second prior art solution described;

FIG. 4 represents a pseudowire set up between first and second routers implementing a communication method of an embodiment of the invention;

FIG. 5 represents steps of a data communication method of an embodiment of the invention;

FIG. 6 represents the steps of a data processing method of an embodiment of the invention;

FIGS. 7A and 7B represent modification request messages broadcast on the pseudowire when implementing the solution of an embodiment of the invention;

FIG. 8 proposes a timing diagram of messages exchanged to request modification of a parameter of the pseudowire set up between the first and second routers;

FIG. 9 represents a router adapted to implement the data communication and processing methods that are the subject matter of an embodiment of the invention.

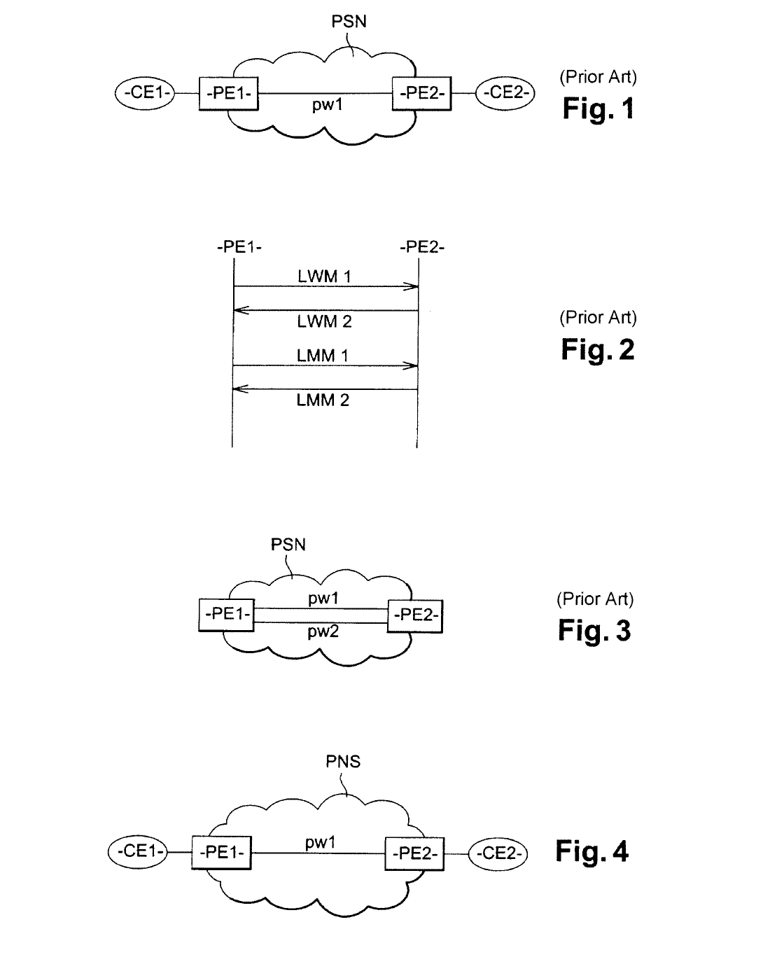

### DETAILED DESCRIPTION OF ILLUSTRATIVE EMBODIMENTS

FIG. 4 represents a connection set up between a first router PE1 and a second router PE2 both at the edge of a packet-switched network PSN.

In this figure, a pseudowire pw1 is set up between the first router PE1 and the second router PE2. The pseudowire pw1 set up in this way transmits data between the router PE1 and the router PE2. Data can be transmitted unidirectionally, i.e. from the router PE2 to the router PE1 or from the router PE1 to the router PE2, or bidirectionally, i.e. from the router PE2 to the router PE1, the uplink transmission direction, and from the router PE1 to the router PE2, the downlink transmission direction.

One example of an application of an embodiment of the invention is traffic collection for a mobile network. In such an example, a first customer edge equipment CE1 such as a base station transmits data over the pseudowire pw1 to the router PE2, which is connected to other customer edge equipments CE2 such as a radio network controller (RNC). According to an embodiment of the invention, the pseudowire pw1 is set up at the initiative of the router PE1 and by exchanging LDP set-up messages.

Accordingly, the router PE1 sends the router PE2 a first set-up message. This first set-up message includes an identifier SAII1 of the input router PE1, an identifier TAII2 of the output router PE2, a parameter of the pseudowire, and a first label LBL0. This first label LBL0 must be added to the header of all the data sent by the router PE2 to the router PE1 over the pseudowire pw1.

Such a parameter of the pseudowire is a function of the data format that the router PE1 is adapted to receive and process. The router PE1 processes data sent by the router PE2 over the pseudowire pw1 with a predetermined format and then transmits it to the customer edge equipment CE1. One such format is the volume of data. Accordingly the data to be encapsulated and transmitted over the pseudowire pw1 can be divided into blocks of 15 payload bits or a fixed number of ATM cells. The router PE1 is configured to encapsulate the data according to this predetermined format.

Other examples of parameters of the pseudowire include the number of an ATM cell virtual channel, the number of ATM cells, and the number of TDM time slots.

On receiving this first set-up message, the router PE2 sends the router PE1 a second set-up message including an identifier SAII2 of the router PE2, an identifier TAII1 of the router PE1, parameters of the pseudowire, and a second label. This second label is added to the header of all data sent by the router PE1 to the router PE2 over the pseudowire pw1. This second set-up message is sent only if the pseudowire pw1 between the routers PE1 and PE2 is bidirectional.

Once the pseudowire pw1 has been set up between the router PE1 and the router PE2, it transmits data with a first format between the router PE1 and the router PE2 bidirectionally, during a data transmission stage PH1.

Two forwarding equivalent classes (FEC) each identifying one transmission direction of the same pseudowire pw1 consist of the pairs {identifier SAII2 of router PE1/identifier TAII2 of router PE2} and (identifier SAII2 of router PE2/identifier TAII1 of router PEI}.

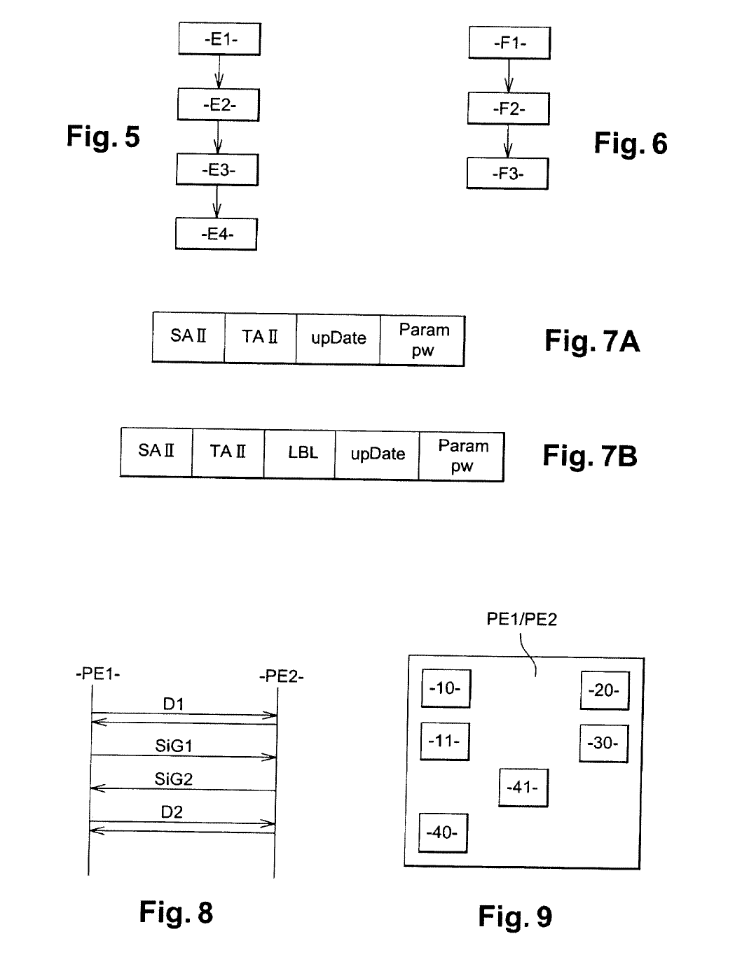

To increase the bit rate of the pseudowire pw1 it is necessary to modify the format of the data to be received by the first router PE1, which uses the data communication method of an embodiment of the invention and the steps of which are represented in FIG. 5. The data communication method is used during a data transmission stage PH1 between the router PE1 and the router PE2 over the pseudowire pw1.

Accordingly, during a step E1, the router PE1 sends the router PE2 a first modification request message SIG1 of a parameter of the pseudowire pw1 to be used for the uplink direction.

One example of such a first modification request message SIG1 is represented in FIG. 7A. This message includes an FEC {SAII1/TAII2} for identifying the downlink transmission direction of the pseudowire pw1, a field containing a parameter upDate indicating that the message SIG1 is a modification request message of a pseudowire, and a field containing a new value of the parameter of the pseudowire pw1 to be used for the uplink direction. The new value of the parameter of the pseudowire pw1 is the new format for encapsulating data to be sent to the router PE1.

After this first step E1, the router PE1 is configured to accept to receive data with the new format sent by the router PE2 over the pseudowire pw1, the stage PH1 of transmitting data with the first format still being in progress.

During a step E2, the router PE2 receives the first message SIG1 requesting modification of a parameter of the pseudowire pw1.

If the pseudowire pw1 provides for bidirectional transmission of data between the router PE1 and PE2, the router PE2 sends a second modification request message SIG2 of a parameter of the pseudowire pw1 to be used for the downlink direction during a step E3. This step is triggered by reception of the first modification request message SIG1.

The second message SIG2 includes an FEC {SAII2/TAII1} for identifying the uplink transmission direction of the pseudowire pw1, a field containing a parameter upDate indicating that the message is a pseudowire modification request message, and a field containing the new value of the parameter of the pseudowire pw1 to be used for the downlink direction.

During a step E4, the router PE1 receives the second message SIG2 requesting modification of a parameter of the pseudowire pw1 for the downlink direction.

How the router PE1 processes the second modification request message SIG2 is described below with reference to FIG. 6.

FIG. 6 represents various steps of the data processing method of an embodiment of the invention.

In one particular implementation of the invention, the router PE2 receives during a step F1 the first modification request message SIG1 of a parameter of the pseudowire pw1 sent by the router PE1 during the step E1 of the data communication method of an embodiment of the invention.

During a step F2, the router PE2 modifies the parameter of the pseudowire pw1 in accordance with the indications contained in the first modification request message SIG1.

During a step F3, the router PE2 marks the data blocks to be sent to the router PE1 according to the modified format in order to inform the router PE1 that it has taken note of the new parameter of the pseudowire pw1 for the uplink direction. This marking constitutes an implicit acknowledgement, sent to the router PE1, of reception of the first modification request message SIG1 by the router PE2.

In a first implementation, the data blocks to be sent to the router PE1 are marked during the step F3 by the router PE2 with a sequence number. Before reception of the first modification request message, the data blocks sent by the router PE2 to the router PE1 over the pseudowire pw1 are marked by means of a sequence number the value of which is incremented by one unit each time the blocks of data are sent. After receiving the first modification request message SIG1, the router PE2 initializes the sequence numbers. Accordingly, when the first data blocks with the new format are sent, the router PE2 associates a sequence number equal to 1 with the first data block sent according to the new format, the value of the sequence number being incremented by one unit as the data blocks in accordance with the new format are sent.

In a second implementation, the router PE2 marks the data blocks to be sent to the router PE1 by means of a first label. Before reception of the first modification request message, the data blocks sent by the router PE2 to the router PE1 over the pseudowire pw1 are marked by means of a label LBL0. When the first data blocks in accordance with the new format are sent, the router PE2 adds to their header a new label LBL1. The router PE2 obtains the value of this label LBL1 from the first modification request message.

FIG. 7B shows an example of such a first configuration message in this second implementation of the invention. This message includes an FEC {SAII1/TAII2} for identifying the pseudowire pw1, a label LBL1, a field containing a parameter upDate indicating that the message is a modification request message of a pseudowire, and a field containing at least one parameter of the pseudowire pw1.

After this step F3, data is sent by the router receiving the first modification request message according to the new format.

Reception by the router PE1 of data sent by the router PE2 with the new format constitutes an implicit acknowledgement of reception by the router PE2 of the modification request message of a parameter of the pseudowire pw1 for the uplink direction.

Once this implicit acknowledgement by the router PE2 has been received, the router PE1 no longer accepts data sent with the first format. If such data is transmitted to the router PE1 over the pseudowire pw1 it rejects the data and does not process it.

The router PE1 executes the data processing method of an embodiment of the invention after it receives the second modification request message of a parameter of the pseudowire pw1 to use for the downlink direction during the step E4 of the communication method described above with reference to FIG. 5.

It is clear that in the method of an embodiment of the invention either of the routers PE1 or PE2 can initiate sending of the first modification request message of a parameter of the pseudowire pw1.

FIG. 8 shows messages exchanged between the router PE1 and the router PE2 during execution of the solution of an embodiment of the invention during a stage PH1 of transmitting data over a pseudowire pw1 enabling bidirectional transmission of data.

A data stream D1 is transmitted between the routers PE1 and PE2 over the pseudowire pw1. This data stream includes data comprising 15 payload bits, for example. Accordingly, when setting up the pseudowire pw1 the parameters of the pseudowire pw1 contained in the messages for setting up the pseudowire for the uplink and downlink transmission directions indicate that the data transmitted by the pseudowire pw1 comprises 15 payload bits.

According to an embodiment of the invention, if there is a format modification in the router PE1, for example, it sends (E1) the router PE2 a first modification request message SIG1 of the parameter of the pseudowire pw1 for the uplink transmission direction. Such a first message SIG1 includes the new value of the parameter of the pseudowire pw1 to be used for the uplink direction.

The format modification in the router PE1 is for example an increase in the number of payload bits of the data from 15 to 20. Accordingly, the modification request message SIG1 indicates that the new number of payload bits of data transmitted in the uplink direction by the pseudowire pw1 is 20.

On receiving (E2, F1) this first modification request message SIG1, the router PE2 modifies (F2) the parameters of the pseudowire pw1 for the uplink transmission direction.

If there is also a format modification in the router PE2, it sends (E3) the router PE1 a second modification request message SIG2 of the parameter of the pseudowire pw1 for the downlink transmission direction including the new value of the parameter of the pseudowire pw1 to be used for the downlink direction. This parameter is the new number of payload bits of the data, here 20. The value of the new parameter of the pseudowire for the uplink direction can be different from the new value of the parameter of the pseudowire for the downlink direction, the two transmission directions being independent of each other.

On receiving (E4, F1) this second modification request message SIG2, the router PE1 modifies (F2) the parameters of the pseudowire pw1 to use for the downlink transmission direction.

To inform the router PE1 that the data sent are in accordance with the new format, in the first implementation of the invention the router PE2 initializes the sequence number to 1 so that the first data blocks sent to the router PE1 with a payload of 20 bits are associated with the sequence number 1. These data blocks constitute a data stream D2.

When the router PE1 receiving the data identifies the value of the sequence number associated with a data block as being 1, it concludes that the data sent by the router PE2 is now data with a payload of 20 bits. This constitutes an implicit acknowledgement of reception by the router PE2 of the first modification request message SIG1.

In the second implementation, the presence of the label LBL1 in the header of the data blocks received by the router PE1 informs the router that data sent by the router PE2 now has a payload of 20 bits.

After sending the first modification request message SIG1 to the router PE2, the router PE1 is able to receive data encapsulated to the old format, i.e. data blocks having a payload of 15 bits, and data conforming to the new format, i.e. data blocks having a payload of 20 bits.

Although the pseudowire pw1 has been modified following the exchange of modification request messages, and is able to transmit data having a payload of 20 bits, the customer edge equipments CE1 can continue to generate data with a payload of 15 bits for a while.

The pseudowire pw1 being able to transmit only data packets with a payload of 20 bits, the routers PE1 and PE2 fill out the payload with stuffing bits. Thus if one of the customer edge equipments CE1, CE2 generates data with a payload of 15 bits, the router PE1, PE2 sending the data adds five stuffing bits before sending the data.

If the format modification consists in reducing the payload of the data, for example from 15 bits to 10 bits, it is necessary for the customer edge equipments CE1, CE2 to generate data with a payload of 10 bits before executing the method of an embodiment of the invention. The pseudowire pw1 being able to transmit only data packets with a payload of 15 bits, the routers PE1 and PE2 fill out the payload with stuffing bits. According to an embodiment of the invention, if one of the customer edge equipments CE1, CE2 generates data with a payload of 10 bits, the router PE1, PE2 sending the data adds five stuffing bits before sending the data until the pseudowire pw1 is modified.

FIG. 9 represents a router PE1, PE2 adapted to execute the communication method of an embodiment of the invention.

Such a router PE1, PE2 includes means 10 for sending a modification request message of a parameter of a pseudowire pw1 set up between it and a second router PE1, PE2 and means 11 for transmitting data.

The router PE1, PE2 of an embodiment of the invention also includes means 40 for receiving the modification request message and means 41 for modifying the parameter of the pseudowire pw1 included in a field of the modification request message.

When the first implementation of the invention is used, the router PE1, PE2 includes means 20 for adding a sequence number for marking data sent to the second router PE1, PE2.

When the second implementation of the invention is used, the first router PE1, PE2 includes means 30 for adding a label LBL1, LBL2 to the header of the data to be sent.

An embodiment of the invention also provides a first computer program, in particular a computer program on or in an information medium or memory, adapted to execute the first stage of the communication method of the invention.

Finally, an embodiment of the invention further provides a second computer program, in particular a computer program on or in an information medium or memory, adapted to execute the second stage of the communication method of an embodiment of the invention.

These programs can use any programming language and take the form of source code, object code or a code intermediate between source code and object code, such as a partially-compiled form, or any other desirable form for implementing the broadcasting and reception methods of an embodiment of the invention.

The information medium can be any entity or device capable of storing the programs. For example, the medium can include storage means, such as a ROM, for example a CD ROM or a micro-electronic circuit ROM, or magnetic storage means, for example a floppy disk or a hard disk.

Moreover, the information medium can be a transmissible medium such as an electrical or optical signal, which can be routed via an electrical or optical cable, by radio or by other means. The programs of an embodiment of the invention can in particular be downloaded over an Internet-type network.

Although the present disclosure has been described with reference to one or more examples, workers skilled in the art will recognize that changes may be made in form and detail without departing from the scope of the disclosure and/or the appended claims.

1. A method of communication between first and second routers, said routers being part of a packet-switched network, said method including:
a stage of transmitting data over a pseudowire set up between the first and second routers, said data being transmitted in accordance with a parameter of said pseudowire; and
at least one step of sending a modification request message of said parameter of said pseudowire at the initiative of one of the two routers, to the other router, and during the stage of transmission over the pseudowire.

2. A communication method according to claim 1, wherein the method includes a configuration step after which the router sending said modification request message is able to accept to receive data transmitted in accordance with said parameter modified in compliance with said modification request.

3. A communication method according to claim 1, wherein the method includes a step of the router that initiated the sending of said modification request message receiving a second modification request message of the parameter of said pseudowire.

4. A communication method according to claim 1 wherein said step of sending said modification request message is executed by said other router in response to a first modification request message of the parameter of the pseudowire.

5. A method of processing data transmitted over a pseudowire set up between first and second routers, said routers being part of a packet-switched network, said method including:
a stage of transmission of data over said pseudowire, said data being transmitted in accordance with a parameter of said pseudowire; and
during the transmission stage:
a step of at least one of the routers receiving a modification request message of the parameter of said pseudowire; and
a step of said router modifying the parameter of said pseudowire in accordance with said received modification request message.

6. A processing method according to claim 5, wherein the method includes a step of said router marking data to be transmitted over the pseudowire having the parameter that has been modified.

7. A processing method according to claim 6, wherein said data is marked by a label added to the header of said data, and the label is included in said received modification request message.

8. A processing method according to claim 6, wherein said data is marked by means of a sequence number.

9. A router that is part of a packet-switched network, said router including:
means for transmitting data over a pseudowire set up between said router and a second router that is part of said packet-switched network, said data being transmitted in accordance with a parameter of said pseudowire; and
means for sending the second router a modification request message of the parameter of said pseudowire.

10. A router according to claim 9, wherein the router includes means for receiving a second modification request message of the parameter of said pseudowire.

11. A router that is part of a packet-switched network, said router including:
means for transmitting data over a pseudowire set up between said router and a first router that is part of said packet-switched network, said data being transmitted in accordance with a parameter of said pseudowire; and
means for receiving a modification request message of the parameter of said pseudowire sent over said pseudowire and means for modifying the parameter of said pseudowire.

12. A router according to claim 11, wherein the router includes means for marking data to be transmitted over the pseudowire having a parameter that is modified.

13. A computer program product stored on a computer-readable medium and/or executable by a processor, wherein the product includes program code instructions for executing a method of communication between first and second routers, said routers being part of a packet-switched network, when said program is executed by a computer, said method including:
a stage of transmitting data over a pseudowire set up between the first and second routers, said data being transmitted in accordance with a parameter of said pseudowire; and
at least one step of sending a modification request message of said parameter of said pseudowire at the initiative of one of the two routers, to the other router, and during the stage of transmission over the pseudowire.

14. A computer program product stored on a computer-readable medium and/or executable by a processor, wherein the product includes program code instructions for executing a method of processing data transmitted over a pseudowire set up between first and second routers, said routers being part of a packet-switched network, when said program is executed by a computer, said method including:
a stage of transmission of data over said pseudowire, said data being transmitted in accordance with a parameter of said pseudowire; and
during the transmission stage:
a step of at least one of the routers receiving a modification request message of the parameter of said pseudowire; and
a step of said router modifying the parameter of said pseudowire in accordance with said received modification request message.

15. A method comprising:
generating a signal that carries a modification request message of at least one parameter of a pseudowire set up between a first router and a second router, said first and second routers being part of a packet-switched network; and
transmitting said signal over the pseudowire.

16. A method according to claim 15, wherein the signal includes:
an identifier of said pseudowire;
a parameter indicating that the signal is a modification request message of a parameter of the pseudowire;
a field containing the modified parameter of the pseudowire.
